(19) United States
(12) Patent Application Publication
(10) Pub. No.: US 2021/0405483 A1
(43) Pub. Date: Dec. 30, 2021

(54) DISPLAY PANEL AND DISPLAY DEVICE

(71) Applicant: WUHAN CHINA STAR OPTOELECTRONICS TECHNOLOGY CO., LTD., Wuhan, Hubei (CN)

(72) Inventor: Yuehua YANG, Wuhan, Hubei (CN)

(21) Appl. No.: 16/632,094

(22) PCT Filed: Nov. 6, 2019
(86) PCT No.: PCT/CN2019/116032

§ 371 Date: Jan. 17, 2020

(30) Foreign Application Priority Data
Aug. 22, 2019 (CN) 201910776756.8

(51) Int. Cl. G02F 1/1362

(52) U.S. Cl. CPC G02F 1/136286

(57) ABSTRACT

Embodiments of the present disclosure refer to a display panel and a display device utilizing the same. In the embodiments of the present disclosure, a plurality of common lines are parallelly located at sides of the plurality of data lines in a display area and the plurality of common lines are connected with a common electrode layer through a plurality of vias, thus making the common voltage in the display area become even, diminishing the difference between the best Vcom on the edge of the display panel and the best Vcom in the center of the display panel, and improving flicker in the periphery of the display panel.

### TECHNICAL FIELD

The present disclosure relates to the field of display technology, and specifically to a display panel and a display device utilizing the same.

### BACKGROUND

The display device can transform the computer data into various words, numbers, symbols or visual images for display and can input the commands or data into the computer by using the keyboard and other input tools. With the help of hardware and software of the system, the display contents can be added, deleted and changed at any time. Display devices can be classified into types of plasma type, liquid crystal type, light emitting diode type and cathode-ray tube type according to the display elements used.

Liquid crystal display (LCD) panel adopts the liquid crystal materials as a basic component and is filled with the liquid crystal materials between two parallel plates. An image with different shades and good arrangement is displayed by achieving a purpose of shielding from light and transmitting light through changing orientational directions of molecules of the liquid crystal materials via applied voltage, and a colorful image can be displayed by further adding a tricolor filter layer between the two plates.

Thin film transistor liquid crystal display (TFT-LCD) panel is a mainstream of liquid crystal display (LCD) panel at present, which is developed from an original LCD technology. In an active TFT-LCD, each pixel has a thin film transistor (TFT) having a gate connected with a horizontal scan line, a drain connected with a vertical data line and a source connected with a pixel electrode. Applying a sufficient voltage to the horizontal scan line can turn on all of the TFTs on the horizontal scan line, and at this time, pixel electrodes of the horizontal scan line are connected with the vertical data line, thereby writing a display signal of the data line to the pixels to control rotation directions of liquid crystal molecules by changing signals and voltages applied to the TFT, thereby achieving a display purpose by controlling whether or not polarized light emits from each pixel. Each pixel is provided with a semiconductor switch to achieve complete and separate control of the pixel in TFT-LCD. The liquid crystal materials are sandwiched between a TFT glass layer and a color filter layer. By controlling voltages stimulating the liquid crystal, the rotation directions of liquid crystal molecules are controlled so as to control whether or not polarized light emits from each pixel, thereby achieving a display purpose, controlling light intensity and colors appearing finally.

Wherein a TFT-LCD with a touch function can be called an in cell display panel and a TFT-LCD without a touch function can be called an add-on display panel. The common electrode of the add-on display panel is composed of indium tin oxide (ITO) covering the entire display area. A circle of metal common line is disposed at the periphery of a display area and the ITO is connected with the common line through vias. The common electrode is affected by the coupling between the scan line, data line and pixel electrode. During a display period, the voltage on the common electrode keeps changing. Due to the high resistivity of ITO, the voltage of part of the common electrode close to the common line recovers quickly after being affected by the coupling, while the voltage of the common electrode in the center of the display area recovers slowly after being affected by the coupling, leading to an uneven common voltage in the display area. When the common voltage in the display area is uneven, the difference between the best Vcom (the minimum Vcom that makes the display flicker) on the edge of the display panel and the best Vcom in the center of the display panel is great, resulting in flicker in the periphery of the display panel. Therefore, a new display panel is needed to solve the above problems.

### SUMMARY

The present disclosure is to provide a display panel and a display device to avoid the great difference between the best Vcom on the edge of the display panel and the best Vcom in the center of the display panel due to the uneven common voltage in the display area, and to avoid the flicker in the periphery of the display panel.

To solve above problems, an embodiment of the present disclosure provides a display panel having a display area and a non-display area, wherein the display panel in the display area comprises a substrate layer, a metal layer, a planarization layer and a common electrode layer. Wherein the metal layer is located on the substrate layer, the planarization layer is located on the metal layer and the common electrode layer is located on the planarization layer. Wherein the metal layer comprises a plurality of data lines and a plurality of common lines. Wherein the plurality of data lines are parallelly spaced apart from each other, the plurality of common lines are parallelly located at sides of the plurality of data lines and the plurality of common lines are connected with the common electrode layer through a plurality of vias.

In an embodiment, distances between each two adjacent common lines of the plurality of common lines are equal to each other.

In an embodiment, one data line of the plurality of data lines is located between each two adjacent common lines of the plurality of common lines.

In an embodiment, two or more than two data lines of the plurality of data lines are located between each two adjacent common lines of the plurality of common lines.

In an embodiment, metal materials of the plurality of data lines and metal materials of the plurality of common lines are the same.

In an embodiment, the display panel further comprises an insulation layer and a pixel electrode layer, wherein the insulation layer is located on the common electrode layer and the pixel electrode layer is located on the insulation layer.

In an embodiment, materials of the common electrode layer and the pixel electrode layer comprise indium tin oxide.

In an embodiment, materials of the planarization layer comprise organic insulation materials.

In an embodiment, materials of the insulation layer comprise inorganic insulation materials.

An embodiment of the present disclosure further provides a display device comprising the display panel provided in the embodiments of the present disclosure.

Embodiments of the present disclosure provide a display panel and a display device utilizing the same. In the embodiments of the present disclosure, a plurality of common lines are parallelly located at sides of a plurality of data lines and the plurality of common lines are connected with a common electrode layer through a plurality of vias, thus making the common voltage in the display area become even, diminishing the difference between the best Vcom on the edge of the display panel and the best Vcom in the center of the display panel, and improving flicker in the periphery of the display panel.

### BRIEF DESCRIPTION OF DRAWINGS

To describe the technical solutions of the embodiments of the present invention more clearly, the following briefly introduces the accompanying drawings used in the description of the embodiments of the present invention. Apparently, the accompanying drawings described below illustrate only some exemplary embodiments of the present invention, and persons skilled in the art may derive other drawings from the drawings without making creative efforts.

FIG. 1 is a schematic plan view illustrating a display panel, according to a first embodiment of the present disclosure.

FIG. 2 is a schematic structure diagram illustrating a display area of the display panel, according to the first embodiment of the present disclosure.

FIG. 3 is a schematic plan view illustrating the display area of the display panel, according to the first embodiment of the present disclosure.

FIG. 4 is a schematic structure diagram illustrating a display area of a display panel, according to a second embodiment of the present disclosure.

FIG. 5 is a schematic plan view illustrating the display area of the display panel, according to the second embodiment of the present disclosure.

FIG. 6 is a schematic plan view illustrating a display panel, according to a third embodiment of the present disclosure.

FIG. 7 is a schematic plan view illustrating a display area of the display panel, according to the third embodiment of the present disclosure

FIG. 8 is a schematic plan view illustrating a display area of a display panel, according to a fourth embodiment of the present disclosure.

The components in the figures are referred as follows: 100—display panel, 101—display area, 102—non-display area, 1—substrate layer, 2—metal layer, 3—planarization layer, 4—common electrode layer, 5—insulation layer, 6—pixel electrode layer, 7—via, 11—substrate, 12—functional layer, 21—data line and 22—common line.

### DETAILED DESCRIPTION OF PREFERRED EMBODIMENTS

Preferred embodiments of the present disclosure will be described in detail hereinafter with reference to the accompanying drawings, to fully introduce technical content of the present disclosure to a person skilled in the art, to testify that the present disclosure can be implemented as examples, to better clarify technical content of the present disclosure, to assist the person skilled in the art in easier understanding how to implement the present disclosure. However, the present disclosure can be embodied in many different forms, the scope of the present disclosure is not limited to the embodiments mentioned in the text, and the description of the embodiments in the following text is not used to limit the scope of the present disclosure.

Orientational words mentioned in the present disclosure, such as up, down, front, rear, left, right, inside, outside and side, are not used to limit the protection scope of the present disclosure.

In the accompanying drawings, elements with identical structure are marked with the same reference numerals for convenient understanding and description. The dimension and thickness of each of the elements in the accompanying drawings are arbitrarily shown, and the present disclosure does not define the dimension and thickness of each of the elements.

When an element is referred to as being on another element, it can be directly on the other element, or there may be an intermediate element on which the element is placed, and the intermediate element is placed on the other element. When an element is referred to as being mounted to or connected to another element, either one can be understood as being directly mounted or connected, or via an intermediate element to be indirectly mounted to or connected to the other element.

### The First Embodiment

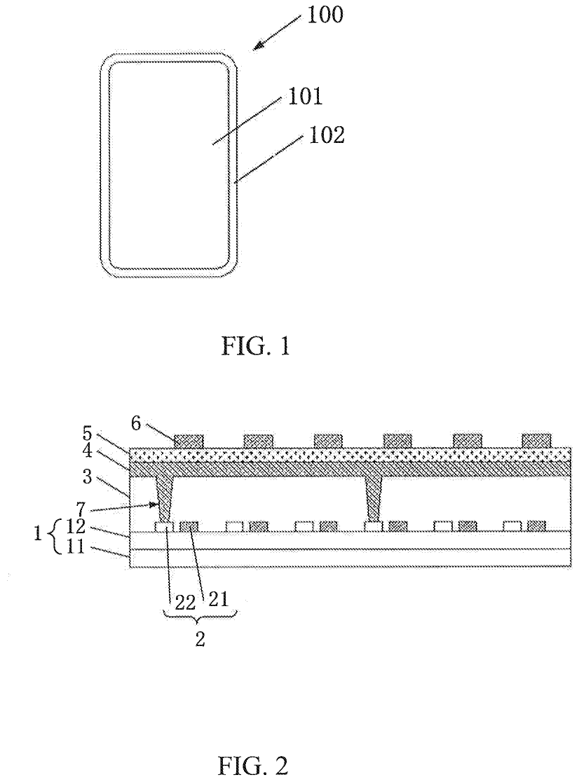

As shown in FIG. 1, a display panel has a display area 101 and a non-display area 102 surrounding the display area 101.

As shown in FIG. 2 and FIG. 3, the display panel 100 in the display area 101 comprises a substrate layer 1, a metal layer 2, a planarization layer 3, a common electrode layer 4, an insulation layer 5 and a pixel electrode layer 6. Wherein the substrate layer 1 comprises a substrate 11 and a functional layer 12. The functional layer 12 comprises structures such as a buffer layer, an active layer, a gate layer and an insulation layer disposed on the substrate 11 in sequence, and details are not further described herein.

As shown in FIG. 2 and FIG. 3, the metal layer 2 is disposed on the substrate layer 1. Wherein the metal layer 2 comprises a plurality of data lines 21 and a plurality of common lines 22. The plurality of data lines 21 are parallelly spaced apart from each other, the plurality of common lines 22 are parallelly located at sides of the plurality of data lines 21 and the plurality of common lines 22 are connected with the common electrode layer 4 through a plurality of vias 7.

As shown in FIG. 2 and FIG. 3, distances between each two adjacent common lines 22 are equal to each other. In detail, one data line 21 can be located between each two adjacent common lines 22 or two or more than two data lines 21 can be located between each two adjacent common lines 22. In the embodiment, there are three data lines 21 located between each two adjacent common lines 22. In other word, each common lines 22 can be located at a side of one corresponding data line 21 or can be located at a side of a same number of corresponding data lines 21. Wherein metal materials of the plurality of data lines 21 and metal materials of the plurality of common lines 22 are the same.

In the embodiment, the plurality of common lines 22 are parallelly located at sides of the plurality of data lines 21, thus making the common voltage in the display area 101 become even, diminishing the difference between the best Vcom on the edge of the display panel and the best Vcom in the center of the display panel, and improving flicker in the periphery of the display panel.

As shown in FIG. 2, the planarization layer 3 is located on the metal layer 2, wherein materials of the planarization layer 3 comprise organic insulation materials. Due to the planarizing function of the planarization layer 3, it is convenient for manufacturing of following structures. Adoption of insulation materials can prevent from contact between the metal layer 2 and the common electrode layer 4 resulted in short circuit, and avoids affecting display effect of the display panel 100.

As shown in FIG. 2, the common electrode layer 4 is located on the planarization layer 3, wherein materials of the common electrode layer comprise indium tin oxide. Thus the resulting common electrode layer 4 has a good conductivity.

As shown in FIG. 2, the insulation layer 5 is located on the common electrode layer 4, wherein materials of the insulation layer 5 comprise inorganic insulation materials, thus preventing from contact between the common electrode layer 4 and the pixel electrode layer 6 resulted in short circuit, and avoiding affecting display effect of the display panel 100.

As shown in FIG. 2, the pixel electrode layer 6 is located on the insulation layer 5, wherein materials of the pixel electrode layer 6 comprise indium tin oxide. Thus the resulting pixel electrode layer 6 has a good conductivity.

### The Second Embodiment

A plan view of the display panel 100 provided in the embodiment is similar to FIG. 1, and details are not further described herein.

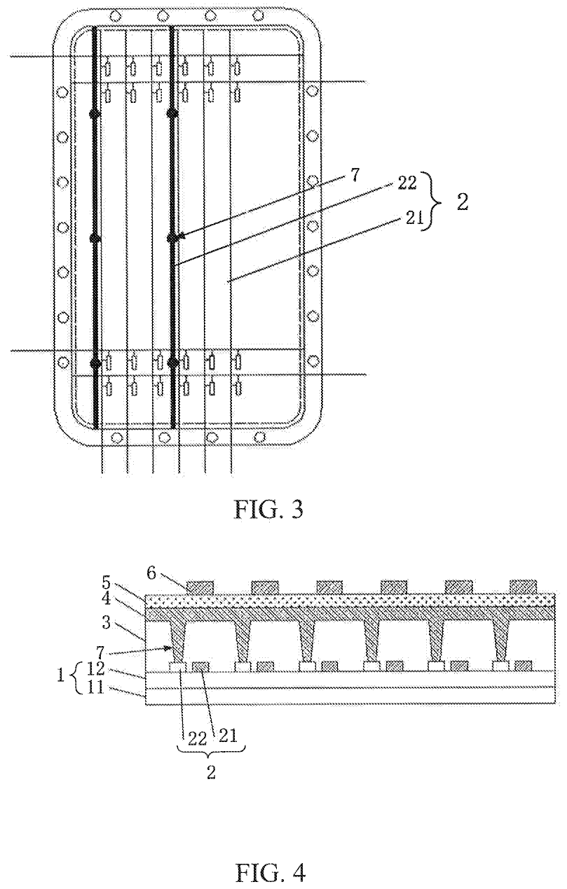

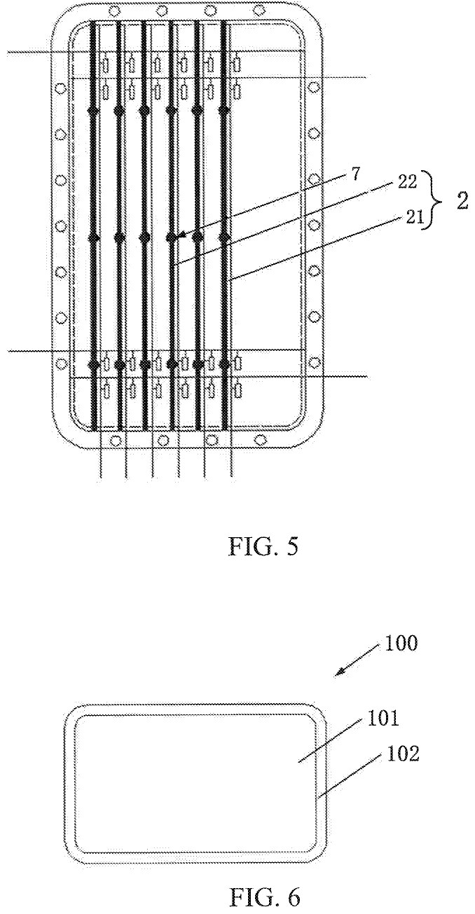

As shown in FIG. 4 and FIG. 5, the difference between the display panel 100 provided in the embodiment and the display panel 100 provided in the first embodiment is that one common line 22 is parallelly located at a side of each data line 21 and is made of a same layer of metal film to constitute the data line 21 in the embodiment, thus making the common voltage in the display area 101 become even, diminishing the difference between the best Vcom on the edge of the display panel and the best Vcom in the center of the display panel, and improving flicker in the periphery of the display panel.

### The Third Embodiment

As shown in FIG. 6, the display panel 100 provided in the embodiment is displayed in a landscape mode, wherein a schematic structure diagram of the display panel 100 in the display area 101 provided in the embodiment is similar to FIG. 1, and details are not further described herein.

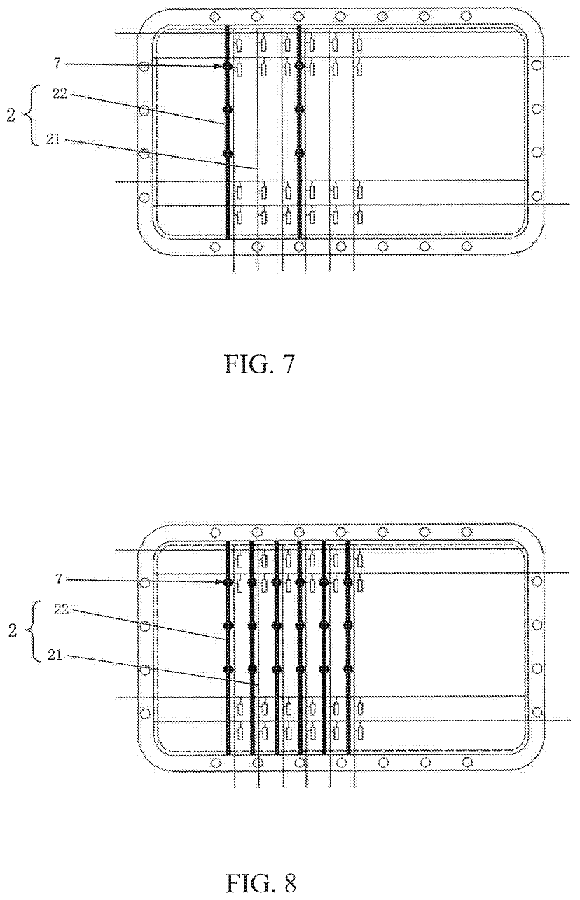

As shown in FIG. 7, the difference between the display panel 100 provided in the embodiment and the display panel 100 provided in the first embodiment is that the display panel 100 provided in the embodiment is suitable for a medium size screen, while the display panel 100 provided in the first embodiment is suitable for a small size screen, in other word, the display panel 100 provided in the first embodiment is displayed in a portrait mode, while the display panel 100 provided in the embodiment is displayed in a landscape mode. In detail, a screen with a size of less than 8 inches can be defined as a small size screen and a screen with a size of more than 8 inches can be defined as a medium size screen.

In the same way, the plurality of common lines 22 are parallelly located at sides of the plurality of data lines 21 and there are three data lines 21 located between each two adjacent common lines 22 in the embodiment, thus making the common voltage in the display area 101 become even, diminishing the difference between the best Vcom on the edge of the display panel and the best Vcom in the center of the display panel, and improving flicker in the periphery of the display panel.

### The Fourth Embodiment

A plan view of the display panel provided in the embodiment is similar to FIG. 6 and a schematic structure diagram of the display panel 100 in the display area 101 provided in the embodiment is similar to FIG. 4, and details are not further described herein.

As shown in FIG. 8, the difference between the display panel 100 provided in the embodiment and the display panel 100 provided in the second embodiment is that the display panel 100 provided in the embodiment is suitable for a medium size screen, while the display panel 100 provided in the second embodiment is suitable for a small size screen, in other word, the display panel 100 provided in the second embodiment is displayed in a portrait mode, while the display panel 100 provided in the embodiment is displayed in a landscape mode. In detail, a screen with a size of less than 8 inches can be defined as a small size screen and a screen with a size of more than 8 inches can be defined as a medium size screen.

In the same way, one common line 22 is parallelly located at a side of each data line 21 and is made of a same layer of metal film to constitute the data line 21 in the embodiment, thus making the common voltage in the display area 101 become even, diminishing the difference between the best Vcom on the edge of the display panel and the best Vcom in the center of the display panel, and improving flicker in the periphery of the display panel.

An embodiment of the present disclosure provides a display device, wherein the display device comprises the display panel 100 provided in the embodiments of the present disclosure.

The display panel and display device provided in the embodiments of the present invention awe described in detail above. It should be understood that the exemplary embodiments described herein should be considered in a descriptive sense only to help understand the method and core ideas of the present disclosure, and not for purposes of limitation to the present disclosure. Descriptions of features or aspects within each embodiment should typically be considered as available for other similar features or aspects in other embodiments. Although the present disclosure has been described with an exemplary embodiment, various changes and modifications may be suggested to one skilled in the art. It is intended that the present disclosure encompass such changes and modifications as fall within the scope of the appended claims. Any amendments, equivalent substitutions, improvements, etc. within the principle of the disclosure are all included in the scope of protection scope as defined in the appended claims of the disclosure.

What is claimed is:

1. A display panel having a display area and a non-display area, the display panel in the display area comprising:
a substrate layer;
a metal layer, located on the substrate layer;
a planarization layer, located on the metal layer; and
a common electrode layer, located on the planarization layer;
wherein, the metal layer comprises:
a plurality of data lines, wherein the plurality of data lines are parallelly spaced apart from each other; and
a plurality of common lines, wherein the plurality of common lines are parallelly located at sides of the plurality of data lines;
wherein the plurality of common lines are connected with the common electrode layer through a plurality of vias.

2. The display panel as claimed in claim 1, wherein distances between each two adjacent common lines of the plurality of common lines are equal to each other.

3. The display panel as claimed in claim 1, wherein one data line of the plurality of data lines is located between each two adjacent common lines of the plurality of common lines.

4. The display panel as claimed in claim 1, wherein two or more than two data lines of the plurality of data lines are located between each two adjacent common lines of the plurality of common lines.

5. The display panel as claimed in claim 1, wherein metal materials of the plurality of data lines and metal materials of the plurality of common lines are the same.

6. The display panel as claimed in claim 1, further comprising:
an insulation layer, located on the common electrode layer; and
a pixel electrode layer, located on the insulation layer.

7. The display panel as claimed in claim 1, wherein materials of the common electrode layer comprise indium tin oxide.

8. The display panel as claimed in claim 6, wherein materials of the pixel electrode layer comprise indium tin oxide.

9. The display panel as claimed in claim 1, wherein materials of the planarization layer comprise organic insulation materials.

10. The display panel as claimed in claim 6, wherein materials of the insulation layer comprise inorganic insulation materials.

11. A display device comprising a display panel, wherein the display panel has a display area and a non-display area, and the display panel in the display area comprise:
a substrate layer;
a metal layer, located on the substrate layer;
a planarization layer, located on the metal layer; and
a common electrode layer, located on the planarization layer;
wherein the metal layer comprises:
a plurality of data lines, wherein the plurality of data lines are parallelly spaced apart; and
a plurality of common lines, wherein the plurality of common lines are parallelly located at sides of the plurality of data lines;
wherein, the plurality of common lines are connected with the common electrode layer through a plurality of vias.

12. The display device as claimed in claim 11, wherein distances between each two adjacent common lines of the plurality of common lines are equal to each other.

13. The display device as claimed in claim 11, wherein one data line of the plurality of data lines is located between each two adjacent common lines of the plurality of common lines.

14. The display device as claimed in claim 11, wherein two or more than two data lines of the plurality of data lines are located between each two adjacent common lines of the plurality of common lines.

15. The display device as claimed in claim 11, wherein metal materials of the plurality of data lines and metal materials of the plurality of common lines are the same.

16. The display device as claimed in claim 11, wherein the display panel further comprises:
an insulation layer, located on the common electrode layer; and
a pixel electrode layer, located on the insulation layer.

17. The display device as claimed in claim 11, wherein materials of the common electrode layer comprise indium tin oxide.

18. The display device as claimed in claim 16, wherein materials of the pixel electrode layer comprise indium tin oxide.

19. The display device as claimed in claim 11, wherein materials of the planarization layer comprise organic insulation materials.

20. The display device as claimed in claim 16, wherein materials of the insulation layer comprise inorganic insulation materials.
